(19) United States
(12) Patent Application Publication
(10) Pub. No.: US 2009/0150298 A1
(43) Pub. Date: Jun. 11, 2009

(54) Computer implemented method for performing waste industry transactions

(76) Inventors: Marc Furman, Summefield, NC (US); Robert Savage, Garden City, NY (US)

Correspondence Address: DILWORTH & BARRESE, LLP, 333 EARLE OVINGTON BLVD., SUITE 702, UNIONDALE, NY, 11553, US

(21) Appl. No.: 12/284,437

(22) Filed: Sep. 22, 2008

Related U.S. Application Data
(60) Provisional application No. 60/994,495, filed on Sep. 20, 2007.

(51) Int. Cl. G06Q 30/00; G06Q 10/00; G06Q 50/00

(52) U.S. Cl. 705/80; 705/400; 705/26

(57) ABSTRACT

A computer-based method and apparatus for trading waste capacity and, other services/goods associated with the waste industry. The computer-based method and apparatus is designed for receipt of electronically listing, buying, selling, trading and bartering all components of the waste industry with potential end users, providers, and investors. The activities involved in the computer-based method is the buying and selling of disposal space in landfills, incinerators, transfer facilities, train car transport, etc. for either concurrent use or to be used or sold at a later time. The method provides a Total Cost Estimator that provides real time information of the actual cost associated with a particular service so as to allow for optimization of profits.

### CROSS-REFERENCE TO RELATED APPLICATIONS

This application claims priority to U.S. Provisional Application Ser. No. 60/964,495 filed Sep. 20, 2007, which is herein incorporated by reference.

### FIELD OF THE INVENTION

The present invention generally relates to a computer-based method and apparatus for trading waste capacity and, more particularly, to a method and apparatus for receipt of electronically listing, buying, selling, trading and bartering all components of the waste industry with potential end users, providers, and investors involved in buying disposal space in landfills, incinerators, transfer facilities, train car transport, etc. for either concurrent use or to be used or sold at a later time, and for an optimized route building matching thereof.

### BACKGROUND OF THE INVENTION

Day after day landfills, wastewater treatment facilities, transfer stations, as well as recycling facilities utilize less than all of the space/tonnage that they are able to legally handle. Also, each day both private and public solid and liquid refuge haulers are in the market to dispose of the waste in which they collect. Sometimes, these haulers are shut out of a local facility, either because the permitted daily limit has been reached or for other reasons. Even though other facilities and/or options may be available to dispose of the waste, often the haulers are unaware of the excess capacity until it is too late. This means lost revenues for the owners of these facilities as well as the haulers.

In addition, the cost associated with the extra labor, travel, fuel, insurance and other cost to dispose of the refuge at a different facility would need to be understood by the hauler prior to pricing the job so that the extra cost, if any, could be passed on to the originator of the refuge.

It is probable that waste haulers frequently search the market, to some degree or extent, to find the lowest cost (or available) refuge disposal site but the information available is sporadic and often not available on a real time basis. In desperate situations it is probable that haulers may turn to alternative facilities, such as transfer stations, that may charge a premium when the local landfills/facilities are closed. Therefore, it is likely that haulers frequently do not obtain the lowest price for disposal and, similarly, disposal facilities do not always operate at capacity or inability to communicate facility capacity to the companies/haulers in need of their services.

That is, it is believed that many waste originators and/or haulers, being limited in their ability to conduct market-wide searches to find the best prices and availability for disposal of the waste they need to dispose of, will either over pay for disposal or employ alternative means, not always legal, to lower their costs and increase their revenues. For example, a hauler may store garbage/waste in a truck overnight against local ordnances so as to wait until the local disposal facility opens. Even worse, haulers may resort to illegally dumping of the waste in an effort to limit cost or prevent loss of profits.

For these and other reasons, it is believed that waste disposal facilities, transfer stations, recycling facilities and related entities as well as haulers of such waste that need to dispose the waste are not presently making substantial use of a mass electronic information exchange network, such as the internet, for posting, marketing and trading their respective goods and services.

Therefore, what is needed is an easy to use computer based system and method that allows the seller of disposal space/services to post, real-time, its available capacity and a hauler of refuge to purchase space with the true cost, including extra labor cost, fuel cost, time, insurance etc, depending on location of the facility and price per unit to dispose prior to purchasing the available disposal capacity.

The present invention is directed to a computerized enabled system for listing, buying, selling, trading and bartering all components of the waste industry with potential end users, providers, and investors involved in buying disposal space in landfills, incinerators, transfer facilities, train car transport, etc. for either concurrent use or to be used or sold at a later time.

### SUMMARY OF THE INVENTION

One embodiment of the present invention is directed to an online real-time, neutral exchange available for posting and purchasing landfill space, transfer station services, waste hauling services, waste recycling services, incineration services, waste pickup, and disposal of any waste commodity of any load type. The present invention is a community of service providers, buyers, sellers, and advertisers, who join the Exchange to buy and sell goods and services that today are cost prohibitive, and extremely complex to manage.

In particular, the present invention is directed to a computer-implemented method for performing waste industry transactions comprising the following steps. Providing a computer enabled network configured to facilitate marketplace communication between a plurality of waste industry participants and inputting data corresponding to at least one posting from at least one transaction requestor of the plurality of waste industry participants to the computer enabled network. The posting is then communicated to the plurality of waste industry participants. The responses are communicated to the at least one posting from at least one transaction responder of the plurality of waste industry participants to the transaction requester and in the event that the transaction requestor and the transaction responder agree to engage in a transaction based on the at least one posting, a confirmation of the transaction is communicated to the transaction responder.

In one embodiment of the present invention the computer-implemented method for performing waste industry transactions further comprises the step of inputting data corresponding to costs of the transaction requestor or the transaction responder associated with the posting and calculating a total cost of engaging in the transaction for the transaction requestor or the transaction responder.

In yet another embodiment of the present invention the computer implemented method for performing waste industry transactions comprises the following steps. Providing an online computer enabled network over a wide area network configured to facilitate marketplace communication via between a plurality of waste producers and a plurality of waste service providers. Inputting data corresponding to at least one posting from at least one of the plurality of waste producers to the computer enabled network. Defining criteria for generating a matching list of selected waste service providers. Comparing the data corresponding to the at least one posting with data corresponding to each of the plurality of waste service providers based on the criteria to determine the matching list of selected waste service providers. Generating the matching list of selected waste service providers. Communicating the posting to the selected waste service providers and communicating responses to the at least one posting from the selected waste service providers. Inputting data corresponding to costs of the at least one waste producer associated with the posting and each of the responses and calculating a total cost of engaging in the transaction for the at least one waste producer for each response. In the event that the at least one waste producer and one of the selected waste service providers agree to engage in a transaction based on the at least one posting, communicating a confirmation of the transaction to the one of the selected waste service providers.

In yet still another embodiment of the invention a waste industry exchange designed to facilitate marketplace communication between a plurality of waste producers and a plurality of waste service providers via an online computer-enabled network is providing. The waste industry exchange comprising a processor-controlled communication interface connected to the network, as well as an input connected to the network. The input is configured to receive data corresponding to at least one posting from at least one of the plurality of waste producers. Also included is a means for communicating the data corresponding to at least one posting to the network and plurality of waste service providers and a means for communicating responses to the at least one posting from the waste service providers to the at least one of the plurality of waste producers. Finally, also included is a means for communicating to at least one of the waste service providers a confirmation of a transaction agreed to engage based on the at least one posting. The computer implemented method described above may further comprise a means for calculating a total cost of engaging in the transaction for the at least one of the plurality of waste producers wherein the costs of engaging in the transaction are selected from the group consisting of transportation costs, fuel costs, labor costs and disposal costs.

The invention of the present invention is further described in the figures and the detailed description of the invention that directly follows.

### BRIEF DESCRIPTION OF THE FIGURES

FIG. 1 represents a screen display showing a bid and an offer by a landfill and a trash holder.

FIG. 2 represents a screen display showing a bid, offer and an actual cost corrected by the shown Total Cost Estimator (TCE).

FIG. 3 shows a flow chart listing the different pathways and types of waste in a waste exchange.

FIG. 4 shows a flow chart with the steps involved in the current state of the landfill space purchase process.

FIG. 5 shows a flow chart with the steps involved in a future state of the landfill space purchase process using the WasteGrid process of the present invention.

### DETAILED DESCRIPTION OF THE INVENTION

The present invention provides a computer implemented method for performing waste industry transactions as well as a waste industry exchange to facilitate marketplace communication between a plurality of waste producers and a plurality of waste service providers via an online computer-enabled network.

The types of waste that may be listed on or services requested for the computer enabled system of the present invention include municipal solid waste, construction and demolition waste as well as specially handled waste, such as, medical and hazardous waste. The system may also include links/ports wherein other types of waste such as wastewater, grease trap waste, yellow (tallo) grease, sanitary waste, cesspool waste, leachate, compost, farm waste (solid and liquid), e-waste (computers) or any other type of liquid or solid material that must be disposed of in a proper manner. The system of the present invention may also include recyclable items such as plastics, rubber, concrete, scrap metal, etc.

In another embodiment of the present invention, a waste producer can post a request for hauling and disposal services a particular waste product and service providers can bid on hauling and disposing of the waste product listed. This allows service providers to use the present invention to both increase their business as well as obtain secure disposal.

The present invention operates much like a stock exchange. A member of the present invention can post any or all of their available landfill space (for instance) on the Exchange, post a price per ton for this space, and sell this space electronically at a competitive rate and providing the best possible liquidity at that point and time. Lowered cost of sales, better exposure to broader markets, and offering competitive rates means fewer inventories goes unsold. When you purchase the landfill space via the present invention, the buyer will be issued an “e-ticket” confirmation that the landfill space has been sold to him, along with the terms and conditions set by the seller in order to cash in on that space. Initially these services will be for a spot market where the sold goods and services are available for consumption immediately.

The present invention can be implemented in a spot market or can be part of a futures market that will accommodate longer range buying and selling in which participants buy and sell commodity/future contracts for delivery on a specified future date. Based on the exchange of the present invention, hedge fund or investment institutions using the exchange of the present invention to buy futures contracts on available landfill space can be established since the prices to dump increase an average of 10-15% per year.

The overall purpose of the system is to place the generator or hauler of a particular waste product with a landfill incinerator, recycling facility, or hauling operators in contact with each other in order to facilitate the movement and proper disposal of waste in both an economical and environmental friendly way, with one stroke of a key. That is, for example, a non-hazardous liquid waste hauler may secure 100,000 gallons of processing space in advance to dispose of liquid waste scheduled to be collected in the up-coming weeks. This is beneficial to the hauler since it assures disposal in the local facility, which closes when it reaches its daily capacity. The facility often closes without warning, so that it can process the collected waste. All haulers that show up after the facility without an e-ticket after the facility has closed will be turned away.

As mentioned above, often liquid-waste haulers may not find out that the processing facility is closed until they arrive at the facility. This can cause total disruption to the haulers' business since the waste hauler would have to either store the liquid waste in the truck overnight, making for a late start on the next days' routine, or drive an additional distance to the next closest facility to dispose of the waste. However, there is no guarantee once it arrives at the second facility that it too has reached its capacity for the day. Thus, purchasing the processing space for the waste water in advance and getting an e-ticket would guarantee that one would not be turned away, thereby saving time, labor and fuel costs. That is, by subscribing to the computer enabled exchange, the waste hauler could either purchase disposal space in advance from local or short-distance away processing facilities and/or transfer stations so as to mitigate the problems associated with being turned away from a closed facility.

The e-ticket of the present invention can be printed in advance with the hauler number imprinted on it so that if it is lost or stolen, it can be reissued. Often, processing facilities require that coupons be purchased by cash or check that if lost, are non-refundable and since they can be used by any other vehicle these are sold or traded by the drivers of these trucks. An e-ticket, much like an airline ticket, on the other hand would have a registration number specific to the company/hauler so that if lost or stolen it can be reissued. The e-ticket also allows the handling of money to be processed by a central office instead by the driver.

All in all, the present invention serves its members, who in turn serve the haulers, transfer stations, landfill operators, etc. In summary, the exchange of the present invention is a central marketplace where waste industry goods and services are posted. Unlike a traditional stock exchange however, buyers and sellers do not need to work through a broker—they deal directly on the exchange of the present invention. The present invention will charge a small transaction fee for every action it runs. Through this web-based interface, the seller is able to define what they would like to post to the exchange of the present invention, watch them in real-time, and control them with exquisite precision, managing them for the best return on investment possible.

In another embodiment of the present invention, business intelligence reports can be generated and published to the personalized portal of buyers and sellers to provide a historical perspective of rates, demand peaks and valleys, and customized reports for accounting and auditing purposes. Since the exchange of the present invention operates much like booking an airline ticket on the Internet does, there is very little overhead associated with collecting fees 30, 60, 90 days out. The spot market demands that the service being bought be paid for and consumed within a short duration of time—much like an airline ticket. The present invention may work with credit card companies like American Express to potentially “white label” the transaction for the user community, creating a secure, reliable experience with well-known transaction providers.

To help the user decide whether it is economical to haul waste to a local disposal site or to a disposal site a greater distance away, the present invention provides a “Total Cost Estimator” (further described below) which allows a hauler to calculate the true cost of hauling the waste to the further disposal site as compared to the closer site without moving from in front of a computer screen.

The “Total Cost Estimator” (TCE) figures out the total cost of disposing of waste, including extra fuel, labor costs and cost to dispose of the waste. This can be done automatically by inputting a few details into a set database, which can be password protected and stored for future use. Using info specific to a user from the password protected database including the size and type of the truck hauling the waste, the start location, labor cost etc., the TCE can calculate the amount of estimated travel time to the disposal facility, the fuel consumed, the labor cost, etc., so as to present a fully loaded cost price per unit of waste. This can be automatically done or done with the stroke of one key. Once completed, the cost of the two facilities can be compared, taking into account the listed factors so that the user can either re-negotiate a cheaper price for disposal in the further facility so as to cover the estimated additional cost or make the deal with the closer facility.

The TCE may include such variables as per mile costs: Gas, time; per day costs: salary, insurance; per trip cost: tolls, etc. as well as other regional and specific variables provided by the user. One Example Equation that can be used is:

Cost Per mile+Costs per day+Cost per trip=TCE.

The TCE is then added to the Offer (sell side price). Over time the TCE could be enhanced to provide a specific route and suggest a hauler to purchase gas in a state such as Ohio where the fuel is cheaper based on the route taken. Advertisement can be sold by ancillary businesses such as truck stops, truck washing facilities, gas stops, etc. and coupons can be printed along with the e-ticket once a particular site is chosen.

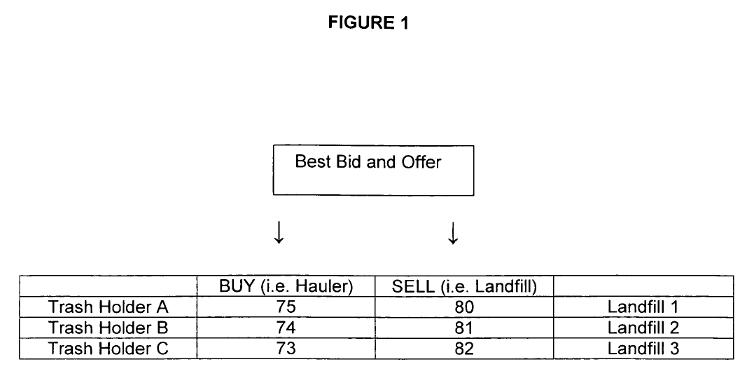

In one embodiment of the present invention, the online real-time, neutral exchange available for posting and purchasing landfill space, transfer station services, waste hauling services, waste recycling services, incineration services, waste pickup, and disposal of any waste commodity of any load type of the present invention comprises an electronic process that matches a buyer and a seller. This process is accomplished by an electronic matching system, which is a key component of the present invention. The electronic matching system displays a two-sided quote, which allows all available sellers and buyers to review available prices for each phase of the waste stream. A typical screen that can be displayed on the exchange is shown in FIG. 1.

In the typical screen shown in FIG. 1, the aggregate prices available for landfill space are provided on the right side with the lowest price available at the top. The left side represents trash holders that have waste that they are looking to get rid of. In this case, a trash holder can buy space at $80 per ton. In addition, a trash holder can submit a price that he is willing to pay if a landfill would like to accept his offer.

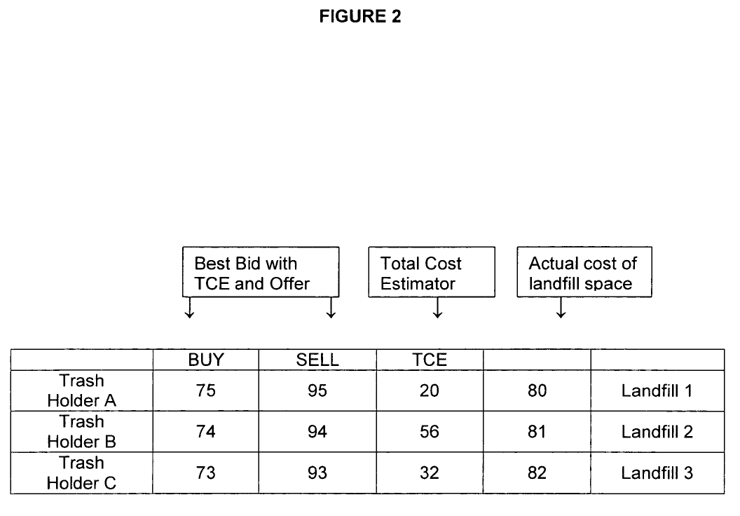

FIG. 2 shows a sample screen correcting the cost of the landfill using the TCE so as to provide information on the actual cost to dump refuge at a particular site. The parameters used to calculate the correction factor known as the TCE can be decided automatically using industry standards for a given region or can be based on information provided by the user. Either way the TCE is a valuable real time component that allows the user to evaluate which transaction to enter based on the actual cost to dump. This allows the user to maximize profits and manage the disposal of collected refuge with the click of several keys. That is, should the user want to compare the true cost including labor, fuel etc., the TCE button can be activated.

As stated above, once the TCE is activated, the TCE will display the total cost associated with purchase or sale of any brokered quantity of waste related to any of the waste stream. This feature will allow the trash holder to factor in additional cost of the purchase such as, but not limited to, fuel, tolls and labor to delivery. This could be used prior to pickup of the refuge so as to be able to price the load accordingly, can be done at the start of each day or can be done using a palm/pda/lap top computer or even the browser on a web enabled phone, as the refuge is in route to the disposal site.

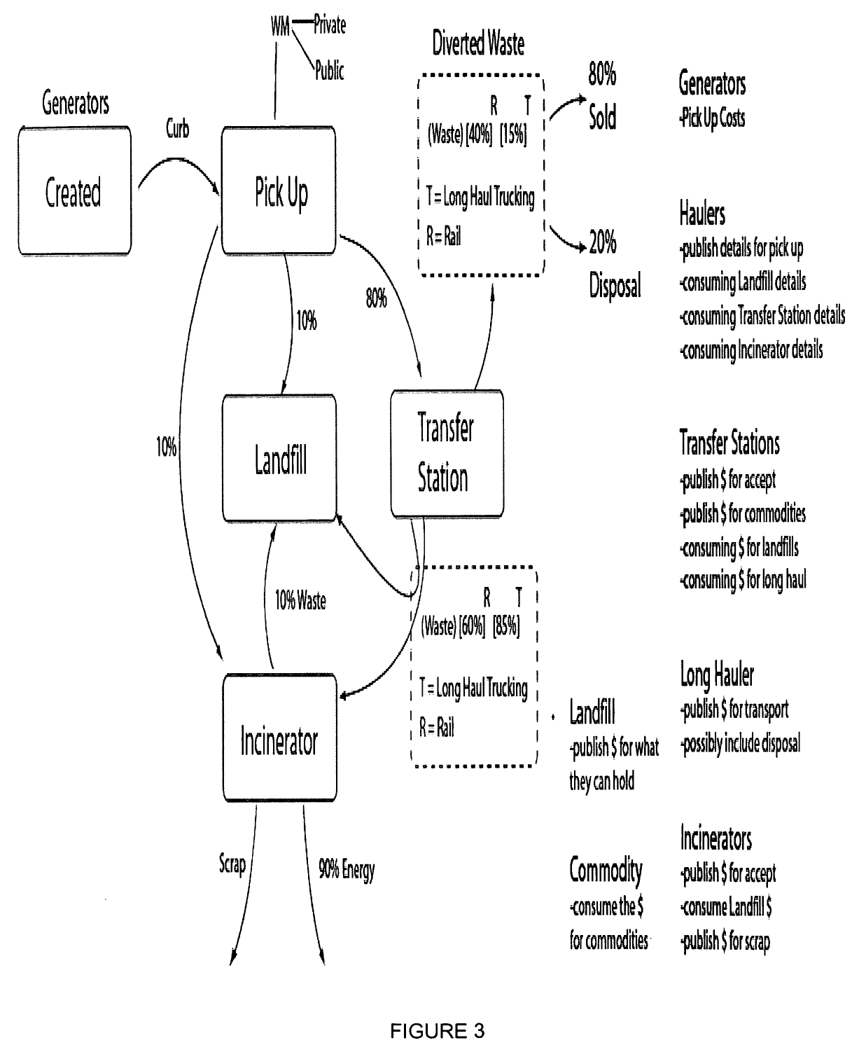

As discussed above, there are many different facets to the waste disposal arena. Many of these facets are represented in the flow chart shown in FIG. 3. Based on this flow chart prices for landfill disposal, incineration facilities, recyclable services, and transfer stations are also included in the exchange of the present invention. Similar screens shown in FIGS. 1 and 2 for prices associated for these services can be displayed along with a TCE associated with each service. The actual cost will be the cost of the service per unit less the TCE so that the user understands, real time, the estimated true cost of disposal and can price disposal accordingly. It is noted, however, that the flow chart shown in FIG. 3 only represents a portion of the complex waste stream process and how the various components participate to dispose of waste. Each of these roles within the process represents a distinct process.

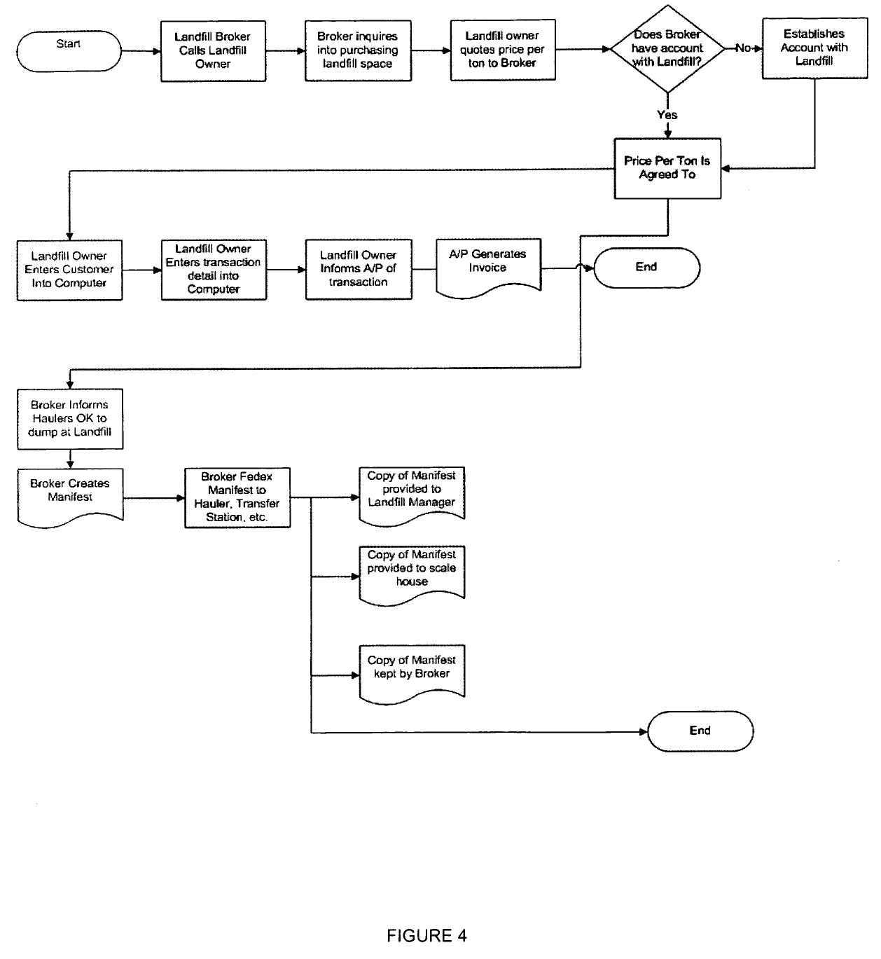

FIG. 4 is a flow chart showing how the purchase of landfill and transfer station space is done currently. This chart includes bids that are usually done over the phone and is only for the actually space. There is no TCE involved to provide the buyer a better understanding of the total cost for dumping at geologically dispersed locations. For example, under the current system without the TCE it may seem cheaper to dump in Ohio at only $25 per ton via a transfer station verses dumping in NJ at $70 per ton but when all costs considered (which is done by the TCE in the current invention) it may actually cost more to dump in Ohio via the transfer station than in NJ. Also under the current system future space cannot be purchased.

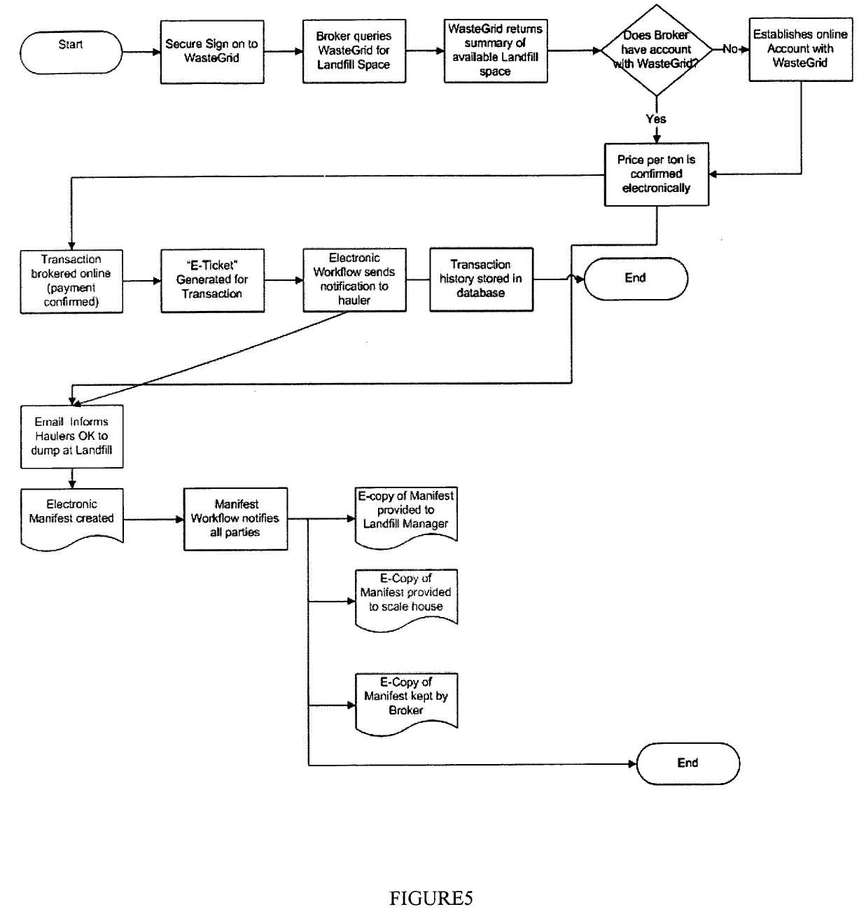

FIG. 5 represents the purchase of Landfill space using the method of the present invention. This includes the TCE and is done electronically over a dedicated network or over the Internet.

Using the method of the current system is fast, easy and allows one to understand the actual cost of the services being purchased in real time. It also allows service providers, such as landfills, to maximize unused availability. For example, when a hauler signs into the exchange of the present invention for a transaction, he will be presented with a personalized electronic dashboard with all of the preferences set the way that a hauler would like to see them. For example:

### Hauler's Portal Perspective.

A tab specific to haulers, displaying data relevant to his job would be provided.
A detail out of the search page from the perspective of the hauler would be provided.
The hauler can then take a look at available landfills for depositing this waste.
They can then search landfills, “Travelocity™” style, looking at prices and distances. For example, a particular landfill will charge so much $/ton of a given material, and distance to that landfill will be given.
“I'm hauling form 12345 Zip Code within 30 miles”. This will bring back results matching their criteria.
They will be presented with a map of routes and options.
“I like this option, let me book this landfill space”

Additional services provided on the exchange of the present invention will range from offering a “coffee talk” series of executive or industry experts from within the waste industry providing community members utilizing the present invention with opportunity to learn and exchange ideas (blogs, etc.). The training may come in the form of Podcasts, video content, or simple PowerPoint like training material. There may also be a Classifieds section where members can post, buy, and sell anything from equipment, landfill liners, 3^{rd} party services, etc.

In addition, Hooks/Links and potentially “white labeling” for the services provided may want to use this service for their own spot market. For example, Nucor Inc. is a major recycling entity focusing on high volume recycling of steel and other metals. Nucor could potentially use the exchange of the present invention to buy recycling services, hauling services, and many more services for a reduced transaction fee on the exchange vs. more time consuming and costly manual methods used today.

A Buy/Sell alternative energy sources section may be used to buy and sell landfill gas, a current commodity that is produced as a byproduct of landfills and used to power small communities, or to supplement existing energy sources. It is envisioned that the buying and selling of this commodity on the exchange of the present invention can either be in a spot and future market, or take a national or global coverage.

Still yet another area Advertising available on the network of the present invention could potentially be a very lucrative revenue-generating component of the exchange of the present invention. Depending on the amount of traffic generated to the site and other factors that drive unique members to the site the selling of advertising space through a traditional internet advertising model is envision as part of the present invention.

Marketing/Industry events/buzz—generating demand will be largely through word of mouth to begin with, however we tend to have regular contributors writing articles on what happening around the waste industry. Existing publications for the waste industry do not have large subscription bases in part due to content that is not relevant to the community at large or is largely outdated. As part of the present invention a new and exciting brand of journalism available through the present invention's website can provide fresh and relevant content.

While the above description contains many specifics, these specifics should not be construed as limitations of the invention but merely as exemplifications of preferred embodiments thereof. Those skilled in the art will envision many other embodiments within the scope and spirit of the invention, which are deemed part of the present invention.

What is claimed is:

1. A computer implemented method for performing waste industry transactions, the method comprising steps of:
providing a computer enabled network configured to facilitate marketplace communication between a plurality of waste industry participants;
inputting data corresponding to at least one posting from at least one transaction requestor of the plurality of waste industry participants to the computer enabled network;
communicating the posting to the plurality of waste industry participants;
communicating responses to the at least one posting from at least one transaction responder of the plurality of waste industry participants to the transaction requester; and
in the event that the transaction requestor and the transaction responder agree to engage in a transaction based on the at least one posting, communicating a confirmation of the transaction to the transaction responder.

2. A computer implemented method according to claim 1, further comprising the step of inputting data corresponding to costs of the transaction requester or the transaction responder associated with the posting and calculating a total cost of engaging in the transaction for the transaction requestor or the transaction responder.

3. A computer implemented method according to claim 2, wherein the costs of the transaction requester or the transaction responder associated with the posting are selected from the group consisting of transportation costs, fuel costs, labor costs and disposal costs.

4. A computer implemented method according to claim 1, wherein the step of providing a computer enabled network includes a local area network.

5. A computer implemented method according to claim 1, wherein the step of providing a computer-enabled network includes a wide area network.

6. A computer implemented method according to claim 1, wherein the transaction is selected from the group consisting of purchasing landfill space, purchasing transfer station services, purchasing waste hauling services, purchasing waste recycling services, purchasing incineration services and purchasing waste pickup.

7. A computer implemented method according to claim 1, wherein the plurality of waste industry participants are selected from the group consisting of service providers, buyers, sellers, investors and advertisers.

8. A computer implemented method according to claim 1, wherein the posting is related to treatment of waste selected from the group consisting of municipal household waste, construction and demolition waste, medical waste, hazardous waste, wastewater, grease trap waste, yellow grease, sanitary waste, cesspool waste, leachate, compost, farm waste and e-waste.

9. A computer implemented method according to claim 1, wherein the posting is related to treatment of recyclable items selected from the group consisting of plastics, rubber, concrete and scrap metal.

10. A computer implemented method according to claim 1, wherein the step of communicating a confirmation of the transaction includes displaying a confirmation from a computer screen.

11. A computer implemented method according to claim 1, wherein the step of communicating a confirmation of the transaction includes displaying a confirmation from printed matter.

12. A computer implemented method according to claim 1, wherein the responses include bids and further comprising the step of displaying the posting and the bids to the plurality of waste industry participants.

13. A computer implemented method according to claim 1, further comprising the step of collecting a fee based on the transaction.

14. A computer implemented method according to claim 1, further comprising the steps of defining criteria for generating a matching list of selected participants, comparing the data corresponding to the at least one posting with data corresponding to each of the plurality of waste industry participants based on the criteria to determine the matching list of selected participants, generating the matching list of selected participants, and communicating the posting to the selected participants.

15. A computer implemented method according to claim 1, wherein the matching list includes the selected participants, the posting and the responses including bids from the selected participants, and further comprising the step of communicating the matching list to the selected participants.

16. A computer implemented method for performing waste industry transactions, the method comprising steps of:
providing an online computer enabled network over a wide area network configured to facilitate marketplace communication between a plurality of waste producers and a plurality of waste service providers;
inputting data corresponding to at least one posting from at least one of the plurality of waste producers to the computer enabled network;
defining criteria for generating a matching list of selected waste service providers;
comparing the data corresponding to the at least one posting with data corresponding to each of the plurality of waste service providers based on the criteria to determine the matching list of selected waste service providers;
generating the matching list of selected waste service providers;
communicating the posting to the selected waste service providers;
communicating responses to the at least one posting from the selected waste service providers;
inputting data corresponding to costs of the at least one waste producer associated with the posting and each of the responses;
calculating a total cost of engaging in the transaction for the at least one waste producer for each response; and
in the event that the at least one waste producer and one of the selected waste service providers agree to engage in a transaction based on the at least one posting, communicating a confirmation of the transaction to the one of the selected waste service providers.

17. A computer implemented method according to claim 16, wherein the matching list includes the selected waste service providers, the posting, the responses including bids from the selected waste service providers and the total cost of engaging in the transaction for the at least one waste producer for each response and further comprising the step of communicating the matching list to the at least one waste producer and the selected waste service providers.

18. A waste industry exchange to facilitate marketplace communication between a plurality of waste producers and a plurality of waste service providers via an online computer-enabled network, the exchange comprising:
a processor-controlled communication interface connected to the network;
an input connected to the network and being configured to receive data corresponding to at least one posting from at least one of the plurality of waste producers;
means for communicating the data corresponding to at least one posting to the network and plurality of waste service providers;
means for communicating responses to the at least one posting from the waste service providers to the at least one of the plurality of waste producers; and
means for communicating to at least one of the waste service providers a confirmation of a transaction agreed to engage based on the at least one posting.

19. A computer implemented method according to claim 18, further comprising means for calculating a total cost of engaging in the transaction for the at least one of the plurality of waste producers.

20. A computer implemented method according to claim 19, wherein the costs of engaging in the transaction are selected from the group consisting of transportation costs, fuel costs, labor costs and disposal costs.
